(19) United States
(12) Patent Application Publication
(10) Pub. No.: US 2017/0290323 A1
(43) Pub. Date: Oct. 12, 2017

(54) Skeeter Eater™ Apparatus and Method for Concentrating then Killing Mosquito Larvae

(71) Applicant: Gerry Miner Welch, Cooperstown, NY (US)

(72) Inventor: Gerry Miner Welch, Cooperstown, NY (US)

(21) Appl. No.: 15/632,679

(22) Filed: Jun. 26, 2017

(51) Int. Cl. A01M 1/22; A01M 1/10; A01M 1/02

(52) U.S. Cl. CPC A01M 1/223; A01M 1/02; A01M 1/106

(57) ABSTRACT

An apparatus for concentrating then killing mosquito larvae, comprising: a mosquito larvae trap for containing a stagnant, stationary pool of water; and an electrical connection for enabling a power source attached to the electrical connection, to introduce an electrical current into the stagnant, stationary pool of water, with a voltage sufficient to electrocute mosquito larvae in the stagnant, stationary pool of water.

### BACKGROUND OF THE INVENTION

According to the American Mosquito Control Association, “Mosquitoes cause more human suffering than any other organism—over one million people worldwide die from mosquito-borne diseases every year. Not only can mosquitoes carry diseases that afflict humans, they also transmit several diseases and parasites that dogs and horses are very susceptible to. These include dog heartworm, West Nile virus (WNV) and Eastern equine encephalitis (EEE). In addition, mosquito bites can cause severe skin irritation through an allergic reaction to the mosquito's saliva—this is what causes the red bump and itching. Mosquito vectored diseases include protozoan diseases, i.e., malaria, filarial diseases such as dog heartworm, and viruses such as dengue, encephalitis and yellow fever.” (http://www.mosquito.org/mosquito-borne-diseases).

It would be desirable to have a device and method to very substantially control and mitigate the health risk of mosquitos both in the Unites States and worldwide.

### SUMMARY OF THE INVENTION

Disclosed herein is an apparatus for concentrating then killing mosquito larvae, comprising: a mosquito larvae trap for containing a stagnant, stationary pool of water; and an electrical connection for enabling a power source attached to the electrical connection, to introduce an electrical current into the stagnant, stationary pool of water, with a voltage sufficient to electrocute mosquito larvae in the stagnant, stationary pool of water.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 illustrates both a top and side plan view of a preferred embodiment of the invention.

### DETAILED DESCRIPTION

It is well known that mosquito breed in stagnant standing water. To take advantage of this natural fact, the invention purposefully creates a localized breeding area for mosquitos to deposit their eggs for hatching into larvae, coupled with a means to electrocute the larvae before maturity at pre-selected time intervals and/or at will. By optimizing the environment for growth such that it is particularly attractive to mosquitos, mosquitos in the nearby area will be drawn to deposit their eggs in the trap rather than at other nearby locales, so that the vast majority of hatched larvae will be bred in a place where they may be destroyed before they mature. The period for maturity may be as short as 4 days and as long as 14 days or more, depending on the type of mosquito and various environmental factors.

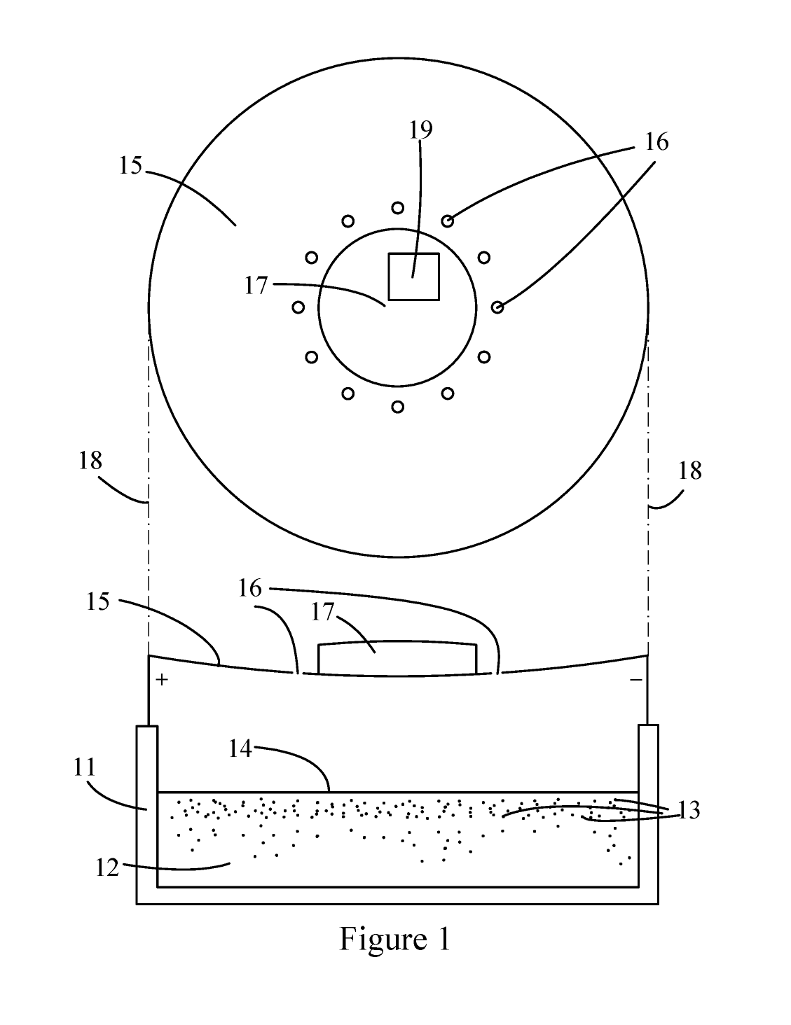

FIG. 1 illustrates the invention in a preferred embodiment, from both a top and side plan view interrelated by the illustrated projection lines 18. A larvae trap 11 comprises a simple pan-like enclosure of any desired shape and size so long as it is capable of containing a stagnant stationary pool of water 12 which is intended to naturally stagnate, as illustrated. Mosquitos will be drawn to deposit their eggs in this trap 11 and once the eggs have hatched, the larvae 13 will tend to accumulate near the top surface 14 of the stagnant water 12.

Situated above the trap 11 is a concave water collector and debris shield 15 for preventing falling leaves, plants, branches, etc. from landing in the trap, and also for collecting rainwater and funneling it into the trap 11 via a plurality of water apertures 16 also as illustrated from both the top and side plan views. This collection of rainwater replaces any water that otherwise evaporates, and ensures that the trap 11 always contains water 12 without the user having to constantly refill the trap 11. Although the projections 18 of FIG. 1 illustrate the water collector and debris shield 15 to have similar diameter to the trap 11, it may be desirable to have the water collector and debris shield 15 comprise a larger diameter so as to increase the surface area over which rainwater may be collected and routed into the trap 11. The concave water collector and debris shield 15 should also be at least an inch or two above the trap 11 with spacing provided to allow mosquitos to gain access to the trap 11.

A power source 17 is conveniently situated atop the center of the water collector and debris shield 15, and is electrically-connected to the trap 11 in such a way as to deliver a voltage into the water 12 so that any larvae 13 living in the trap 11 at the tie will be electrocuted. The positive (+) and negative (−) terminals of the voltage are also illustrated. While FIG. 1 illustrates the power source 17 atop the water collector and debris shield 15, this location is exemplary, not limiting. Any location that is convenient for the power source 17 is regarded to be within the scope of this disclosure and the associated claims. The power source 17 likewise can take any form that is known or may become known in the art, including but not limited to batteries, fuel cells, solar power generators, wind generators, small motors, household currents, and equivalent devices and methods. Also, combination of these aforementioned may be used. For example, power source 17 may comprise a solar collector thereof, used to charge and recharge a battery thereof.

Finally, it is well known how to introduce an electric current into a pool of water, and any means for doing so is also encompassed by this disclosure and its claims. All that is required is to have an electrical connection for enabling a power source 17 attached to said electrical connection, to introduce an electrical current into said stagnant, stationary pool of water 12, with a voltage sufficient to electrocute mosquito larvae 13 in said stagnant, stationary pool of water 12.

Although the trap 11 and the concave water collector and debris shield 15 are illustrated to be circular from the top view, the shape of these components is irrelevant to the functioning of the invention, and any desirable shape is regarded to be within the scope of this this disclosure and the claims. This includes recognition that various artistic shapes may be desired so that the trap and its components blend into the environment in a visually appealing manner.

The voltage to kill the larvae 13 may be activated by the user, at will. Alternatively, or in addition, the power source 17 may be equipped with a schematically-illustrated timer 19 that will zap the stagnant water pool 11 with electrical charge before breeding cycle is complete, killing the mosquito larvae 13. In this way, the trap 11 resets itself and will work continually for extended periods of time. Additionally, the decayed larvae 13 will help to attract the next generation of mosquitos to deposit their eggs in the trap 11. The power source 17 combined with a heating element (not shown) may also use excess electricity to slightly warm the pool of water 12 adding to the water stagnation.

The bottom of the trap 11 may optionally comprise an attached pointed stake or equivalent footing(s) (not shown) for securing the trap 11 to the ground. The manufactured color(s) of the trap 11 can vary from black to lighter colors depending on climate/environment. Darker colors in cooler environments are helpful to warm the water 12 to aid in stagnation, while lighter colors in warner environments are helpful to reduce the rate of evaporation.

Optionally, more advanced versions can be equipped with water reservoirs interconnected with the trap 11 to maintain a constant water level 14 in the trap 11. Additives can be added to the water 11 as an attractant to mosquitos to draw the local mosquito population to lay their eggs in the trap, and/or as an aid in stagnating the water.

These traps can be made light weight, inexpensive, easy to deploy, and simple to maintain. These Skeeter Eater™ devices can be placed just about everywhere: in woods, jungles, backyards, swamps, and anywhere else that mosquitos are a problem.

The knowledge possessed by someone of ordinary skill in the art at the time of this disclosure, including but not limited to the prior art disclosed with this application, is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. An apparatus for concentrating then killing mosquito larvae, comprising:
a mosquito larvae trap for containing a stagnant, stationary pool of water; and
an electrical connection for enabling a power source attached to said electrical connection, to introduce an electrical current into said stagnant, stationary pool of water, with a voltage sufficient to electrocute mosquito larvae in said stagnant, stationary pool of water.

2. The apparatus of claim 1, further comprising a power source attached to said electrical connection.

3. The apparatus of claim 2, said power source selected from at least one of the power source group consisting of: batteries, fuel cells, solar power generators, wind generators, small motors, and household currents.

4. The apparatus of claim 1, further comprising a concave water collector and debris shield situated above said mosquito larvae trap for shielding said mosquito larvae trap from falling debris and for collecting rainwater and funneling it into said trap.

5. The apparatus of claim 1, further comprising a timer for causing said electrical current to be introduced into said stagnant, stationary pool of water, at predetermined times.

6. The apparatus of claim 1, further comprising a water reservoir for maintaining a substantially constant level of said stagnant, stationary pool of water in said mosquito larvae trap.

7. The apparatus of claim 1, further comprising at least one additive for attracting mosquitos to said trap.

8. The apparatus of claim 1, further comprising at least one additive for facilitating the stagnation of said water in said trap.

9. An method for concentrating then killing mosquito larvae, comprising:
providing a stagnant, stationary pool of water contained in a mosquito larvae trap; and
electrocuting mosquito larvae in said stagnant, stationary pool of water by introducing an electrical current into said stagnant, stationary pool of water with sufficient voltage to electrocute the mosquito larvae.

10. The method of claim 9, further comprising introducing an electrical current via an electrical connection between a power source and said stagnant, stationary pool of water.

11. The method of claim 10, said power source selected from at least one of the power source group consisting of: batteries, fuel cells, solar power generators, wind generators, small motors, and household currents.

12. The method of claim 9, further comprising shielding said mosquito larvae trap from falling debris and collecting rainwater and funneling it into said trap, using a concave water collector and debris shield situated above said mosquito larvae trap.

13. The method of claim 9, further introducing said electrical current into said stagnant, stationary pool of water, at predetermined times, responsive to a timer.

14. The method of claim 9, further comprising maintaining a substantially constant level of said stagnant, stationary pool of water in said mosquito larvae trap, using a water reservoir interconnected with said stagnant, stationary pool of water.

15. The method of claim 9, further comprising attracting mosquitos to said trap using at least one additive therefor.

16. The method of claim 9, further comprising facilitating the stagnation of said water in said trap using at least one additive therefor.
